(19) United States
(12) Patent Application Publication
(10) Pub. No.: US 2026/0326404 A1
(43) Pub. Date: Oct. 22, 2026

(54) A PRESS APPARATUS AND A RELATED METHOD

(71) Applicant: Quintus Technologies AB, Västerås (SE)

(72) Inventors: Per BURSTRÖM, Västerås (SE); Robert KARJER, Västerås (SE)

(73) Assignee: Quintus Technologies AB, Västerås (SE)

(21) Appl. No.: 19/486,769

(22) PCT Filed: Jun. 8, 2023
(86) PCT No.: PCT/EP2023/065425

§ 371 Date: Nov. 21, 2025

(51) Int. Cl. B30B 11/00; B30B 15/34

(52) U.S. Cl. CPC B30B 11/002; B30B 15/34

(57) ABSTRACT

A press apparatus is disclosed, comprising a pressure vessel having an internal space and at least one pressure medium guiding path having and extending between an inlet and an outlet in fluid communication with the internal space. The press apparatus comprises a cooling unit arranged downstream the inlet and configured to cool pressure medium being guided in the at least one pressure medium guiding path. At least one pressure medium flow generator is arranged downstream the cooling unit and configured to receive the flow of the pressure medium having been cooled by the cooling unit such that the temperature of the pressure medium does not exceed a first selected temperature and generate a flow of the pressure medium in the at least one pressure medium guiding path towards the outlet. A related method is also disclosed.

### TECHNICAL FIELD

The present invention relates to a press apparatus comprising a pressure vessel having an internal space and being arranged to hold pressure medium within the internal space during use of the press apparatus. The press apparatus may be configured to treat at least one article for example by means of isostatic pressing.

### BACKGROUND

An article to be subjected to pressure treatment by isostatic pressing such as Cold Isostatic Pressing (CIP), Warm Isostatic Pressing (WIP), High Pressure Processing (HPP) or Hot Isostatic Pressing (HIP) is in general positioned in a pressure vessel arranged to hold pressure medium therein. A treatment cycle may comprise loading the article in the pressure vessel, closing and sealing the pressure vessel, treating the article in the pressure vessel, opening the pressure vessel, and unloading the article from the pressure vessel. Several articles may be treated simultaneously. The treatment cycle may be divided into several parts, or phases. After loading an article into the pressure vessel, the pressure vessel may then be sealed, followed by introduction of a pressure medium (e.g., a fluid, such as a gas or liquid such as water or oil) into the pressure vessel such that the pressure in the pressure vessel is increased to a certain pressure level, which may be referred to as a pressurization phase, whereby the article may be subjected to an increased pressure during a selected period of time. The treatment cycle may comprise a heating phase, wherein the pressure medium is heated, e.g., so as to achieve a desired or required temperature thereof. The heating phase may be carried out concurrently with the pressurization phase, before the pressurization phase, or after the pressurization phase. The subjecting of the article to an increased pressure in the pressure vessel during a selected period of time may be referred to as a pressing phase, or holding phase, of the treatment cycle. After the pressing phase and prior to opening the pressure vessel to remove the article, the pressure in the pressure vessel is generally decreased to a sufficiently low level by withdrawing pressure medium from the pressure vessel. This may be referred to as a pressure reduction phase or pressure relief phase. The treatment cycle may further comprise a cooling phase. Depending on the type of isostatic press employed (e.g., whether the isostatic press is configured to carry out CIP, WIP, HPP or HIP), a cooling phase may however not be necessary.

### SUMMARY

Once a desired or required pressure in the pressure vessel and a desired or required temperature of the pressure medium have been achieved, it may be desired to hold the so achieved pressure in the pressure vessel and the temperature of the pressure medium over an extended period of time. The extended period of time may for example be a duration or substantially the entire duration of a pressing phase of the treatment cycle. The inventors have found out that in order to ensure that the temperature of the pressure medium is uniform throughout the pressure vessel—or at least throughout (or substantially throughout) a space in the pressure vessel which the at least one article that is treated is held—it may be beneficial to create and/or maintain a circulation of pressure medium within the pressure vessel during the extended period of time. The space in the pressure vessel in which the at least one article that is treated is held may be referred to as an internal space and may for example be defined by a load compartment. In case there is no circulation of pressure medium within the pressure vessel during such an extended period of time, thermal stratification within the pressure vessel may occur such that the temperature of the pressure medium may vary between different parts within the pressure vessel, which may lead to a non-uniform temperature distribution in the at least one article that is treated or to different temperatures between different articles or components which are treated within the pressure vessel. This may be undesired in many applications, as it could result in properties of the treated at least one article not meeting the intended specifications for the treated articles and/or different treatment conditions for different articles, which may result in different results from the treatment for different articles. One example of such applications may be treatment of solid-state battery (SSB) components, i.e., wherein the at least one article comprises, is constituted by, or is based on one or more SSB components, e.g., all-solid-state battery (ASSB) components, or semi-solid-state battery components. For example, reducing or avoiding temperature variations within different portions of the at least one treated article at the end of a pressing phase of the treatment cycle may be helpful for reducing or avoiding internal stresses in the treated article(s) during a subsequent cooling phase of the treatment cycle, and may provide an efficient way for obtaining article(s) or component(s) with uniform material properties and density while minimizing internal voids and defects without geometrical distortion of the article(s) or component(s). For example, in SSB applications, the inventors have realized that relatively high uniformity in density and other material properties of the SSB component(s) may provide an increased yield from treatment of a large number of SSB components and improve material properties of the treated products, including material properties such as porosity (such as, for example porosity of anode, cathode, electrolyte, catholyte and/or anolyte (composite) materials) and (e.g., volumetric) energy density, as well as electrical properties and electrochemical properties and capacity of the battery cell(s). By reducing the porosity of an article such as an SSB component, the volume expansion of the SSB component during charging of the SSB may decrease, which in turn may increase the lifetime of the SSB.

In view of the above, a concern of the present invention is to provide a press apparatus comprising a pressure vessel having an internal space and being arranged to hold pressure medium within the internal space during use of the press apparatus, which press apparatus is configured to treat at least one article and is capable of reducing or even avoiding any non-uniformity in the temperature distribution in the at least one article that is treated.

To address at least one of this concern and other concerns, a press apparatus and a method in a press apparatus in accordance with the independent claims are provided. Embodiments of the present invention are defined by the dependent claims.

According to a first aspect of the present invention, a press apparatus is provided. The press apparatus comprises a pressure vessel having an internal space. The pressure vessel is arranged to hold pressure medium within the internal space during use of the press apparatus. The press apparatus comprises at least one pressure medium guiding path. The at least one pressure medium guiding path has and extends between an inlet and an outlet, which are in fluid communication with the internal space. The at least one pressure medium guiding path is configured to guide pressure medium from the inlet to the outlet. The press apparatus comprises at least one pressure medium flow generator, which is configured to generate a flow of pressure medium into the inlet, through the at least one pressure medium guiding path, and out of the outlet. The press apparatus comprises a cooling unit, which is arranged downstream the inlet, and which is configured to cool the pressure medium being guided in the at least one pressure medium guiding path. At least one of the at least one pressure medium flow generator is arranged downstream the cooling unit and is configured to receive the flow of the pressure medium having been cooled by the cooling unit and generate a flow of the pressure medium in the at least one pressure medium guiding path towards the outlet. The cooling unit is configured to cool the pressure medium being guided in the at least one pressure medium guiding path such that the temperature of the pressure medium received by said at least one of the at least one pressure medium flow generator does not exceed a first selected temperature.

According to a second aspect of the present invention, a method in a press apparatus is provided. The press apparatus comprises a pressure vessel having an internal space. The pressure vessel is arranged to hold pressure medium within the internal space during use of the press apparatus. The press apparatus comprises at least one pressure medium guiding path. The at least one pressure medium guiding path has and extends between an inlet and an outlet, which are in fluid communication with the internal space. The at least one pressure medium guiding path is configured to guide pressure medium from the inlet to the outlet. The press apparatus comprises at least one pressure medium flow generator, which is configured to controllably generate a flow of pressure medium into the inlet, through the at least one pressure medium guiding path, and out of the outlet. The press apparatus comprises a cooling unit, which is arranged downstream the inlet, and which is configured to controllably cool the pressure medium being guided in the at least one pressure medium guiding path. The method comprises controlling the at least one pressure medium flow generator to generate a flow of pressure medium into the inlet and towards the cooling unit. At least one of the at least one pressure medium flow generator is arranged downstream the cooling unit and is configured to receive the flow of the pressure medium having been cooled by the cooling unit. The method further comprises controlling the at least one of the at least one pressure medium flow generator to generate a flow of the pressure medium in the at least one pressure medium guiding path towards the outlet. The method further comprises controlling the cooling unit to cool the pressure medium being guided in the at least one pressure medium guiding path such that the temperature of the pressure medium received by said at least one of the at least one pressure medium flow generator does not exceed a first selected temperature.

By means of the provisioning of the at least one pressure medium flow path and the at least one pressure medium flow generator, creation and/or maintaining of a circulation of pressure medium within the pressure vessel, for example over an extended period of time, may be facilitated or enabled. In particular, a circulation of pressure medium within the internal space and the load compartment, for example over an extended period of time, may be created and/or maintained. As indicated in the foregoing, creation and/or maintaining such circulation of pressure medium may be advantageous for reducing or even avoiding any non-uniformity in the temperature distribution in the at least one article during use of the press apparatus, e.g., when the at least one article is treated by the press apparatus. In case there would be no circulation of pressure medium within the pressure vessel during a pressing phase of a treatment cycle, the temperature of the pressure medium may vary between different parts within the pressure vessel, which may lead to a non-uniform temperature distribution in the at least one article or to different temperatures between different articles or components which are treated within the pressure vessel, e.g., during or at least at the end of the pressing phase. As mentioned in the foregoing, this may be undesired in many applications, such as, for example, in treatment of SSB components. Reducing or avoiding temperature variations within different portions of the at least one treated article, e.g. at the end of a pressing phase of the treatment cycle, may be helpful for reducing or avoiding internal stresses in the treated article(s) during a subsequent cooling phase of the treatment cycle, and may provide an efficient way for obtaining article(s) or component(s) with a relatively high uniformity in density and other material properties while minimizing internal voids and defects without geometrical distortion of the article(s) or component(s).

Reducing or avoiding temperature variations within different portions of the at least one treated article or between different articles or components which are treated within the pressure vessel may, as indicated above, be particularly beneficial during or at least at the end of the pressing phase, i.e., during or at least at the end of a period of time when the at least one article is subjected to an increased pressure in the pressure vessel. The pressing phase may in alternative be referred to as a holding phase. However, reducing or avoiding temperature variations within different portions of the at least one treated article or between different articles or components which are treated within the pressure vessel may be beneficial also during another or other phases of a treatment cycle, such as, for example, during a heating phase wherein the pressure medium is heated, e.g., so as to achieve a desired or required temperature thereof, in order to keep the time needed to carry out a treatment cycle relatively short.

In SSB components, e.g., ASSB components, there are in general various solid elements which may exhibit diverse or different chemical, physical and/or mechanical properties. Because of this and further due to the nature of the coupling between such solid elements, there may be a relatively large number of internal interfaces within SSB components. In case of treatment of an SSB component such as an ASSB component, reducing or avoiding temperature variations within different portions of the SSB component may be helpful for achieving a uniform densification across internal interfaces the SSB component and a uniform densification of the solid-state electrolyte of the SSB component, and may also be beneficial for inducing desired chemical and electrochemical reactions (e.g., solid electrolyte interphase formation) at internal interfaces of the SSB component. Further, interfaces inside the SSB/ASSB (such as, for example, the interfaces between the current collector anode and the anode composite, between the cathode current collector and the cathode composite, between the cathode and solid-state electrolyte (SSE), and between the anode and SSE) may be enhanced and stabilized.

As known in the art of isostatic pressing, the at least one article to be treated may be placed in a bag or pouch prior to the treatment. By reducing or avoiding temperature variations within different portions of the at least one treated article, any warpage or distortion of the bag or pouch may be mitigated or even eliminated.

The pressure medium may for example comprise a fluid, such as a liquid and/or a gas. The fluid may for example comprise water and/or oil and/or another appropriate liquid. The oil may for example comprise mineral oil. The gas may for example comprise an inert gas, such as argon gas.

The pressure vessel may for example have cylindrical shape. However, while a cylindrical shape of the pressure vessel may be preferred, the pressure vessel could have another shape than a cylindrical shape.

In use, the pressure vessel may for example be arranged such that a longitudinal axis of the pressure vessel is oriented perpendicular or substantially perpendicular to a vertical line (e.g., a plumb line), or such that a longitudinal axis of the pressure vessel is oriented parallel to or substantially parallel to a vertical line (e.g., a plumb line).

The press apparatus may be configured to treat at least one article by means of isostatic pressing. Treatment by means of isostatic pressing facilitates or allows for achieving the same material properties of all articles treated by the press apparatus. For example, the press apparatus may be configured to treat at least one article by means of at least one of Cold Isostatic Pressing (CIP), Warm Isostatic Pressing (WIP), High Pressure Processing (HPP) or Hot Isostatic Pressing (HIP).

In general, the treatment by means of CIP may involve a temperature in the pressure vessel that is equal to or lower than (e.g., about) 50 °C, e.g., in a range between (e.g., about) room temperature (e.g., 20 °C) and (e.g., about) 50 °C, in the pressure vessel. Further, the treatment by means of CIP may involve a pressure in the pressure vessel that is in a range between (e.g., about) 50 MPa to (e.g., about) 1600 MPa, such as between (e.g., about) 50 MPa to (e.g., about) 600 MPa, depending on material of the article(s) being treated and the temperature in the pressure vessel.

In general, the treatment by means of WIP may involve a temperature in the pressure vessel that is in a range between (e.g., about) 50 °C and (e.g., about) 400 °C, in the pressure vessel. Further, the treatment by means of WIP may involve a pressure in the pressure vessel that is in a range between (e.g., about) 50 MPa to (e.g., about) 1600 MPa, such as between (e.g., about) 50 MPa to (e.g., about) 600 MPa, depending on material of the article(s) being treated and the temperature in the pressure vessel.

In general, the treatment by means of HIP may involve a temperature in the pressure vessel that is equal to or higher than (e.g., about) 400 °C, e.g., in a range between (e.g., about) 400 °C and (e.g., about) 2500 °C, in the pressure vessel. Further, the treatment by means of HIP may involve a pressure in the pressure vessel that is in a range between (e.g., about) 50 MPa to (e.g., about) 300 MPa, such as between (e.g., about) 50 MPa to (e.g., about) 210 MPa, depending on material of the article(s) being treated and the temperature in the pressure vessel.

In general, the treatment by means of HPP may involve a temperature in the pressure vessel that is equal to or higher than (e.g., about) 0 °C, e.g., in a range between (e.g., about) 0 °C and (e.g., about) 100 °C, typically in a range between (e.g., about) 4 °C and (e.g., about) 40 °C, in the pressure vessel. Further, the treatment by means of HPP may involve a pressure in the pressure vessel that is in a range between (e.g., about) 100 MPa to (e.g., about) 800 MPa, commonly between (e.g., about) 400 MPa to (e.g., about) 600 MPa, depending on material of the article(s) being treated and the temperature in the pressure vessel.

The “use of the press apparatus” may refer to in principle any use of the press apparatus related to the treatment of the at least one article. For example, the pressure vessel may be arranged to hold pressure medium within the internal space for example during a pressurization phase, a heating phase, a pressing phase and/or another phase of a treatment cycle as mentioned in the foregoing. Thus, “use of the press apparatus” may refer to, e.g., one or more of pressurization, heating, pressing, or cooling, or any combination of such phases and any other possible phases of a treatment cycle.

As mentioned, the press apparatus comprises a cooling unit, which is arranged downstream the inlet and configured to cool the pressure medium being guided in the at least one pressure medium guiding path, and at least one of the at least one pressure medium flow generator is arranged downstream the cooling unit and is configured to receive the flow of the pressure medium having been cooled by the cooling unit and generate a flow of the pressure medium in the at least one pressure medium guiding path towards the outlet. The cooling unit is configured to cool the pressure medium being guided in the at least one pressure medium guiding path such that the temperature of the pressure medium received by said at least one of the at least one pressure medium flow generator does not exceed a first selected temperature. Such a configuration may be particularly advantageous in case the above-mentioned at least one pressure medium flow generator arranged downstream the cooling unit is of a type or configuration that may not function or operate properly or even malfunction in case the temperature of the pressure medium received by the pressure medium flow generator(s) is relatively high. During use of the press apparatus, the temperature of the pressure medium may become relatively high. As mentioned, the press apparatus may be configured to treat at least one article by means of isostatic pressing, in which case the temperature of the pressure medium may become relatively high. In case the temperature of the pressure medium guided into the at least one pressure medium flow path becomes too high for the above-mentioned at least one of the at least one pressure medium flow generator arranged downstream the cooling unit to function or operate properly, the cooling unit may cool the pressure medium being guided in the at least one pressure medium flow path such that the temperature of the pressure medium received by the above-mentioned at least one of the at least one pressure medium flow generator does not exceed a temperature above which that or those pressure medium flow generators may not function or operate properly or possibly even malfunction.

For example, the said at least one of the at least one pressure medium flow generator may be associated with a nominal maximum pressure medium temperature, which may be a temperature which the pressure medium received by the said at least one of the at least one pressure medium flow generator is not permitted to exceed. The above-mentioned first selected temperature may be equal to the nominal maximum pressure medium temperature.

The press apparatus may comprise a heating unit, which may be arranged downstream the said at least one of the at least one pressure medium flow generator and upstream the outlet, and which may be configured to heat the pressure medium being guided in the at least one pressure medium guiding path such that the temperature of the pressure medium in the pressure medium flow out of the outlet is equal to or exceeds a second selected temperature. During use of the press apparatus, the pressure medium upon flowing into the inlet may have a temperature equal to a certain temperature or within a certain temperature range, wherein the certain temperature may exceed the first selected temperature, or the certain temperature range may include temperatures exceeding the first selected temperature. The above-mentioned second selected temperature may be equal to the certain temperature or is within the certain temperature range. Thus, the heating unit may heat the pressure medium being guided in the at least one pressure medium flow path such that the temperature of the pressure medium in the pressure medium flow out of the outlet exceeds or conforms to a selected temperature, which may be the temperature of the pressure medium when guided into the at least one pressure medium flow path via the inlet thereof.

For example, the at least one pressure medium guiding path may be arranged at least in part outside the pressure vessel.

The said at least one of the at least one pressure medium flow generator may for example comprises at least one pressure intensifier.

The heating unit and/or the cooling unit may for example comprise at least one heat exchanger unit.

The at least one pressure medium guiding path may be configured to guide pressure medium out of the internal space and into the inlet, guide the pressure medium introduced into the inlet from the inlet to the outlet, and guide the pressure medium out of the outlet and back into the internal space.

The press apparatus may be configured to treat at least one article. The press apparatus may comprise a load compartment which may be arranged within the internal space and which may be arranged so that a flow of pressure medium through the load compartment is permitted. The load compartment may be arranged to hold at least one article therein during use of the press apparatus.

The at least one pressure medium flow path may be different from the internal space and the load compartment. In general, the at least one pressure medium flow path can be considered to be a part of the press apparatus that is separate from the internal space and/or the load compartment, and possibly such that the pressure medium, when it is being conveyed in the at least one pressure medium flow path, does not mix with the pressure medium that is in the internal space and/or the load compartment.

The at least one pressure medium flow path may for example comprise at least one of one or more conduits, one or more channels, one or more pipes, one or more tubes, etc., which may be configured to guide pressure medium therethrough.

The at least one pressure medium flow generator may be configured to generate a flow of pressure medium within the internal space in a direction from the outlet to the inlet.

The pressure vessel may comprise at least one end closure. The at least one pressure medium guiding path may exit the pressure vessel via a passage through an end closure of the pressure vessel and enter the pressure vessel via a passage through the same end closure. Each or any end closure(s) may be arranged to be able to be selectively opened and closed.

The pressure vessel may comprise at least two end closures. The at least one pressure medium guiding path may exit the pressure vessel via a passage through a first closure of the end closures of the pressure vessel and enter the pressure vessel via a passage through a second end closure of the end closures of the pressure vessel, with the second end closure possibly being different from the first end closure.

The press apparatus may be configured to treat at least one article. At least a portion of the internal space may be arranged to hold the at least one article. The press apparatus may comprise a heating medium reservoir, which may be fluidly connected or fluidly connectable to the pressure vessel. The press apparatus may comprise at least one heater, which may be configured to selectively and controllably heat the heating medium in the heating medium reservoir. The press apparatus may comprise at least one heating medium flow generator, which may be configured to, prior to the pressure vessel holding pressure medium within the internal space for the use of the press apparatus, repeatedly cause a flow of heating medium from the heating medium reservoir into the pressure vessel and subsequently a flow of heating medium from the pressure vessel into the heating medium reservoir to thereby cause a circulation of heating medium between the heating medium reservoir and the pressure vessel during a selected period of time. The at least one heater may be configured to heat the heating medium in the heating medium reservoir, and the at least one heating medium flow generator may be configured to cause a circulation of heating medium between the heating medium reservoir and the pressure vessel during a selected period of time, in such a way to cause any article in the internal space to be heated to a selected temperature. The at least one heating medium flow generator may be configured to, upon the temperature of the article(s) in the internal space having reached the selected temperature, cause a flow of heating medium from the pressure vessel into the heating medium reservoir to withdraw the heating medium from the pressure vessel. By such a configuration, the article(s) to be treated by the press apparatus by means of pressure medium held within the internal space may be preheated prior to the treatment of the article(s) being carried out.

The pressure vessel may comprise a pressure cylinder. The pressure vessel may comprise a pressure cylinder and one or more end closures, such as a first end closure and a second end closure. Possibly, an end closure of the pressure vessel could be constituted by a part of the pressure cylinder. Each or any of the first end closure and/or the second end closure may for example include or be constituted by a lid. The second end closure may be opposite to the first end closure. For example, the first end closure and the second end closure may be arranged at opposite ends of the pressure vessel (or pressure cylinder). Thus, the first end closure may be at a first end of the pressure vessel the second end closure may be at a second end of the pressure vessel.

On or at the outer surface of the outer walls of the pressure cylinder or the pressure vessel there may be arranged channels, conduits and/or tubes, etc., which a flow of coolant may be provided for cooling of the outer walls of the pressure cylinder or pressure vessel. On the outer surface of the outer walls of the pressure cylinder or pressure vessel, and possibly on any channels, conduits and/or tubes, etc. for coolant, pre-stressing means may be provided. In case the pre-stressing means are arranged directly on the outer surface of the outer walls of the pressure cylinder or pressure vessel, the channels, conduits and/or tubes, etc. for coolant may be arranged on the pre-stressing means (e.g., on the outside of the pre-stressing means) so as to at least in part enclose the pre-stressing means. The pre-stressing means may for example be provided in the form of wires (e.g., made of steel) which may be wound in a plurality of turns so as to form one or more bands, and preferably in several layers, around the outer surface of the outer walls of the pressure cylinder or pressure vessel and possibly also any channels, conduits and/or tubes, etc. for coolant that may be provided thereon. The prestressing means may be arranged for exerting radial compressive forces on the pressure cylinder or pressure vessel. According to one example, the pressure vessel may be of the so-called monoblock type, in which case prestressing means as described above might not be used.

Further, the press apparatus may comprise axial prestressing means for accommodating axial forces which may be exerted on one or more of the end closures of the pressure vessel. Such axial prestressing means may for example comprise a frame, which may be arranged to hold one or more of the end closures of the pressure vessel. The frame may extend on the outside the pressure vessel from an end closure at one end of the pressure vessel to an end closure at another end of the pressure vessel.

As mentioned, after loading an article into the pressure vessel, the pressure vessel may then be sealed. This may be followed by a pressurization phase and/or a heating phase. The pressurization phase and the heating phase may be carried out concurrently. The pressurization phase may involve introduction of a pressure medium into the (sealed) pressure vessel to attain a selected pressure within the pressure vessel. The heating phase may involve heating the pressure medium, e.g., so as to achieve a desired or required temperature thereof. Possibly, prior to introducing the pressure medium into the pressure vessel, the pressure medium may be preheated to a temperature that takes account of the adiabatic heating that occurs because of pressurizing of the pressure medium inside of the pressure vessel. Such adiabatic heating may for example be (about) 2-9°C/100 MPa, depending on media composition. By preheating pressure medium prior to introducing the pressure medium into the pressure vessel and then pressurizing the pressure medium inside the pressure vessel, a temperature of the pressure medium within 2 °C-5 °C of the desired or required temperature, for example, may be achieved. Thus, the preheated pressure medium may be introduced into the pressure vessel. Subsequently, the temperature of the pressure medium may be adjusted to the desired or required temperature (or to almost the desired or required temperature) by means of adjusting the pressure in the pressure vessel such that the desired or required temperature (or to almost the desired or required temperature) is reached by means of adiabatic heating of the pressure medium. Thus, by means of such adiabatic heating, the temperature of the pressure medium in the pressure vessel may be increased by, e.g., 2 °C-5 °C, in order to reach the desired or required temperature (or to almost the desired or required temperature. The preheating of the pressure medium may for example be carried out using one or more heaters, e.g., one or more electrical heaters, arranged in relation to a pressure medium source or reservoir connected or connectable to the pressure vessel so as to be able to heat the pressure medium while in the pressure medium source or reservoir.

As mentioned, the pressure medium may for example comprise water. Water is normally considered to be incompressible. At very high pressures, however, water is compressible, and heat is developed during the compression. In principle, the temperature of water increases by approximately 4 °C for every 1000 bar up to 6000 bar. The interaction between the amount of (solid) load or article(s) to be treated and the pressure medium (e.g., water) may affect how operation of a press apparatus configured to treat at least one article by means of, e.g., WIP is or should be controlled. The solid load/article(s) will be negligibly compressible in comparison to the pressure medium, and the temperature increase of the solid load/article(s) as a result of the pressure increase will therefore not be the same as the temperature increase of the pressure medium as a result of the pressure increase. The thermal properties of the load/article(s) should be taken into account when choosing how to control operation of a press apparatus configured to treat at least one article by means of, e.g., WIP (e.g., when choosing control parameters for such operation). For example, the pressure build-up speed and which preheating temperature to be used (if any) should be considered. Because the increase in temperature of the pressure medium over a given period of time during a pressure build-up sequence may be different than the increase in temperature of the load/article(s) over that period of time during a pressure build-up sequence, depending on the above-mentioned considerations, this should be taken into account for determining which pressure build-up speed to use. A rapid pressure build-up may not be required in case the temperature of the load/article(s) is held at a constant level below the target ‘hold’ temperature for a certain time during the time it takes to reach the target ‘hold’ pressure. This means that a slower pressure build-up in some cases may be preferred in order to be able to reach the target ‘hold’ temperature and the target ‘hold’ pressure simultaneously or substantially simultaneously. Also, the controlling of the operation may also need to take into account any nominal maximum temperature and/or a nominal maximum pressure which may not be permitted to be exceeded due to safety reasons.

The preheating of the article(s) prior to the treatment of the article(s) may be carried out while the article(s) are outside the pressure vessel. Possibly, the article(s) may be preheated outside the pressure vessel while the article(s) is or are being arranged within a container for accommodating the article(s) and which may be configured to be arranged in the pressure vessel during the treatment of the article(s) by means of the press apparatus. The container might be of a configuration usually referred to as a load basket.

The press apparatus may comprise a heating unit, which may be arranged downstream the said at least one of the at least one pressure medium flow generator and upstream the outlet, and which may be configured to controllably heat the pressure medium being guided in the at least one pressure medium guiding path. The method according to the second aspect of the present invention may comprise controlling the heating unit to heat the pressure medium being guided in the at least one pressure medium guiding path such that the temperature of the pressure medium in the pressure medium flow out of the outlet is equal to or exceeds a second selected temperature.

According to a third aspect of the present invention, a computer program product is provided. The computer program product is configured to, when executed in a control unit configured to control operation of a press apparatus according to the first aspect of the present invention, perform a method according to the second aspect of the present invention.

According to a fourth aspect of the present invention, a computer-readable storage medium is provided. On the computer-readable storage medium there is stored a computer program product configured to, when executed in a control unit configured to control operation of a press apparatus according to the first aspect of the present invention, perform a method according to the second aspect of the present invention.

The control unit may be configured to control operation of one or more components of the press apparatus, such as the at least one pressure medium flow generator, the cooling unit and/or the heating unit.

The control unit may be communicatively coupled with one or more components of the press apparatus, such as the at least one pressure medium flow generator, the cooling unit and/or the heating unit, e.g., by means of any wired and/or wireless communication means, such as, for example, any appropriate wired and/or wireless communication means as known in the art. The control unit may be configured to control operation of one or more components of the press apparatus, such as the at least one pressure medium flow generator, the cooling unit and/or the heating unit, by transmission of one or more messages or commands, data, etc. thereto, which one or more messages or commands, data, etc. may cause the one or more components of the press apparatus to perform, e.g., a method according to the second aspect of the present invention.

The control unit may alternatively be referred to as a controller, a control module, or control circuitry. The control unit may for example include or be constituted by any suitable central processing unit (CPU), a programmable logic microcontroller (PLC), a microcontroller, digital signal processor (DSP), Application Specific Integrated Circuit (ASIC), Field Programmable Gate Array (FPGA), etc., or any combination thereof. The control unit may optionally be capable of executing software instructions stored in a computer program product, e.g., in the form of a memory. The memory may for example be any combination of read and write memory (RAM) and read only memory (ROM). The memory may comprise persistent storage, which for example can be a magnetic memory, an optical memory, a solid-state memory or a remotely mounted memory, or any combination thereof.

The computer-readable storage medium may for example include a Digital Versatile Disc (DVD) or a floppy disk or any other suitable type of computer-readable means or computer-readable (digital) storage medium, such as, but not limited to, a memory such as, for example, nonvolatile memory, a hard disk drive, a Compact Disc (CD), a Flash memory, magnetic tape, a Universal Serial Bus (USB) memory device, a Zip drive, etc.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the present invention will be described below with reference to the accompanying drawings.

FIG. 1 is a schematic view of a press apparatus according to an embodiment of the present invention.

FIG. 2 is a schematic, in part sectional view of a pressure vessel of a press apparatus according to an embodiment of the present invention.

FIG. 3 is a schematic, in part sectional view of a part of the pressure vessel depicted in FIG. 2 at one end closure thereof.

FIG. 4 is a schematic, in part sectional view of a part of the pressure vessel depicted in FIG. 2 at the other end closure thereof.

FIG. 5 is a perspective view of the end closure depicted in FIG. 4.

FIG. 6 is a schematic view of a press apparatus according to an embodiment of the present invention.

FIG. 7 is a schematic, in part sectional view of a pressure vessel of a press apparatus according to an embodiment of the present invention.

FIG. 8 is a schematic flowchart of a method according to an embodiment of the present invention.

FIG. 9 is a schematic flowchart of a method according to an embodiment of the present invention.

The figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are illustrated. The present invention may, however, be embodied in many different forms and should not be construed as limited to the embodiments of the present invention set forth herein; rather, these embodiments are provided by way of example so that this disclosure will convey the scope of the present invention to those skilled in the art.

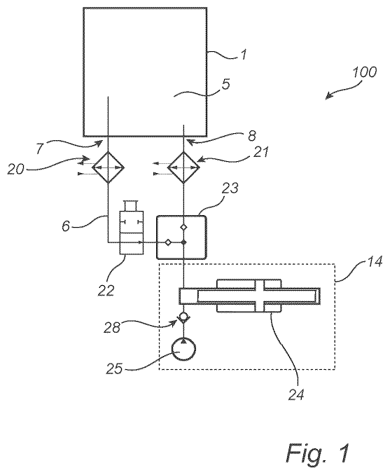

FIG. 1 is a schematic view of a press apparatus 100 according to an embodiment of the present invention. The press apparatus 100 comprises a pressure vessel 1. The pressure vessel 1 has an internal space 5. The pressure vessel 1 is arranged to hold pressure medium within the internal space 5 during use of the press apparatus 100. The press apparatus 100 may be configured to treat at least one article (not shown in FIG. 1). The press apparatus 100 may comprise a load compartment (not shown in FIG. 1), which may be arranged within the internal space 5, and which may be arranged so that a flow of pressure medium through the load compartment is permitted. The load compartment may be arranged to hold the at least one article therein during use of the press apparatus 100. The pressure medium may for example comprise a fluid, such as a liquid and/or a gas. The fluid may for example comprise water and/or oil and/or another appropriate liquid. The oil may for example comprise mineral oil. The gas may for example comprise an inert gas, such as argon gas.

The press apparatus 100 comprises a pressure medium guiding path 6. The pressure medium guiding path 6 has and extends between an inlet 7 and an outlet 8 which are in fluid communication with the internal space 5. The pressure medium guiding path 6 is configured to guide pressure medium from the inlet 7 to the outlet 8. The pressure medium flow path 6 may for example be defined by at least one of one or more tubes, one or more pipes, one or more channels, one or more conduits, etc. It is to be understood that while FIG. 1 illustrates one pressure medium guiding path 6, the press apparatus 100 may comprise several pressure medium guiding paths, wherein each may be configured to guide pressure medium from the inlet 7 to the outlet 8. Each or any of several pressure medium guiding paths may be configured to guide pressure medium from an inlet to an outlet which are in fluid communication with the internal space 5. Thus, there may be an inlet and an outlet associated with each of several pressure medium guiding paths.

The pressure medium guiding path 6 may be configured to guide pressure medium out of the internal space 5 and into the inlet 7, guide the pressure medium introduced into the inlet 7 from the inlet 7 to the outlet 8, and guide the pressure medium out of the outlet 8 and back into the internal space 5.

In accordance with the embodiment of the present invention illustrated in FIG. 1, the pressure medium guiding path 6 is arranged at least in part outside the pressure vessel 1. It is to be understood that this is not required, and that the pressure medium guiding path 6 could be at least in part be arranged inside the pressure vessel 1.

FIG. 1 schematically illustrates the pressure medium flow path 6 exiting the pressure vessel 1 at one location and entering the pressure vessel 1 at another location. The extension of the pressure medium flow path 6 between different locations at or in the pressure vessel 1 may be realized in different ways. For example, the pressure vessel 1 might comprise at least two end closures, such as a first end closure and a second end closure (not shown in FIG. 1). The pressure medium guiding path 6 might exit the pressure vessel 1 via a passage through a first end closure of the end closures of the pressure vessel 1 and enters the pressure vessel 1 via a passage through a second end closure of the end closures of the pressure vessel 1. The second end closure may be different from the first end closure, or the second end closure may be the same as the first end closure (i.e., the pressure medium guiding path 6 might exit and enter the pressure vessel 1 in or at a single end closure of the pressure vessel 1).

The press apparatus 100 comprises at least one pressure medium flow generator configured to generate a flow of pressure medium into the inlet 7, through the pressure medium guiding path 6, and out of the outlet 8. The at least one pressure medium flow generator may be configured to generate a flow of pressure medium within the internal space 5 in a direction from the outlet 8 to the inlet 7. Thus, by means of the at least one pressure medium flow generator and the pressure medium guiding path 6, a circulation of pressure medium within the internal space 5, for example over an extended period of time, may be created and/or maintained. The circulation may be carried out during a pressing phase, or holding phase, of the treatment cycle, wherein any article in the pressure vessel 1 is subjected to an increased pressure (e.g., at or about a certain pressure in the pressure vessel 1 and possibly at or about at a certain temperature in the pressure vessel 1) in the pressure vessel 1 during a (e.g., selected) period of time.

The press apparatus 100 comprises a cooling unit 20, which is arranged downstream the inlet 7, and which is configured to cool the pressure medium that is being guided in the pressure medium guiding path 6.

At least one pressure medium flow generator 14 of the at least one pressure medium flow generator is arranged downstream the cooling unit 20. The said at least one pressure medium flow generator 14 of the at least one pressure medium flow generator is configured to receive the flow of the pressure medium having been cooled by the cooling unit 20 and generate a flow of the pressure medium in the pressure medium guiding path 6 towards the outlet 8. The press apparatus 100 may comprise one or more additional pressure medium flow generators, each or any of which for example may be arranged within the pressure vessel 1, and each or any of which for example may comprise one or more fans, one or more ejectors, and/or one or more pumps.

In accordance with the embodiment of the present invention illustrated in FIG. 1, the said at least one pressure medium flow generator 14 of the at least one pressure medium flow generator comprises a pressure intensifier 24 and a pump 25, which pump 25 may be referred to as a feeding pump.

The cooling unit 20 is configured to cool the pressure medium that is being guided in the pressure medium guiding path 6 such that the temperature of the pressure medium received by the said at least one pressure medium flow generator 14 of the at least one pressure medium flow generator does not exceed a first selected temperature.

The said at least one pressure medium flow generator 14 of the at least one pressure medium flow generator may be associated with a nominal maximum pressure medium temperature, which may be a temperature which the pressure medium received by the said at least one pressure medium flow generator 14 of the at least one pressure medium flow generator is not permitted to exceed. The above-mentioned first selected temperature may be equal to the nominal maximum pressure medium temperature.

In accordance with the embodiment of the present invention illustrated in FIG. 1, the press apparatus 100 comprises a heating unit 21. The heating unit 21 is arranged downstream the said at least one pressure medium flow generator 14 of the at least one pressure medium flow generator and upstream the outlet 8. The heating unit 21 is configured to heat the pressure medium that is being guided in the pressure medium guiding path 6 such that the temperature of the pressure medium in the pressure medium flow out of the outlet 8 is equal to or exceeds a second selected temperature.

Each or any of the cooling unit 20 and the heating unit 21 may for example comprise one or more heat exchanger units, although another or other types of heating/cooling units are possible.

During use of the press apparatus 100, the pressure medium upon flowing into the inlet 7 may have a temperature equal to a certain temperature or within a certain temperature range. The said certain temperature may exceed the above-mentioned first selected temperature, or the certain temperature range may include temperatures exceeding the above-mentioned first selected temperature. The above-mentioned second selected temperature may be equal to the said certain temperature or be within the said certain temperature range.

For example, and in accordance with the embodiment of the present invention illustrated in FIG. 1, the pressure intensifier 24 may not function or operate properly or even malfunction in case the temperature of the pressure medium received by the pressure medium flow generator 14 (e.g., the pressure intensifier 24) would be relatively high. The cooling unit 20 may cool the pressure medium in the pressure medium flow path 6 to ensure that the temperature of the pressure medium received by the pressure medium flow generator 14 (e.g., the pressure intensifier 24) does not exceed a temperature for which the pressure medium flow generator 14, such as the pressure intensifier 24, is not rated. That temperature may be referred to as a nominal maximum pressure medium temperature as mentioned in the foregoing. In case it would be determined (e.g., sensed) that that the temperature of the pressure medium which will be received by the pressure medium flow generator 14 (e.g., the pressure intensifier 24) does not exceed the temperature for which the pressure medium flow generator 14, such as the pressure intensifier 24, is not rated, the cooling unit 20 may not carry out any cooling of the pressure medium in the pressure medium flow path 6, or only to adjust the temperature of the pressure medium in the pressure medium flow path 6 towards any setpoint which may be defined, for example.

A configuration of the press apparatus 100—and particularly a configuration of the pressure medium flow path 6—such as illustrated in FIG. 1 may be particularly advantageous in case the pressure medium flow generator 14 is of a type or configuration that may not function or operate properly or even malfunction in case the temperature of the pressure medium received by the pressure medium flow generator 14 would be relatively high. For example, the press apparatus 100 may be configured to treat at least one article by means of isostatic pressing, in which case the temperature of the pressure medium may become relatively high during use of the press apparatus 100. In case the temperature of the pressure medium guided into the pressure medium flow path 6 becomes too high for the pressure medium flow generator 14 to function properly, the cooling unit 20 may cool the pressure medium being guided in the pressure medium flow path 6 such that the temperature of the pressure medium received by the pressure medium flow generator 14 does not exceed a temperature above which the pressure medium flow generator 14 may not function or operate properly or possibly even malfunction. Possibly, the heating unit 21 may then heat the pressure medium being guided in the pressure medium flow path 6 such that the temperature of the pressure medium in the pressure medium flow out of the outlet 8 exceeds or conforms to a selected temperature, which may be a temperature equal to or about the temperature of the pressure medium when guided into pressure medium flow path 6 via the inlet 7.

In accordance with the embodiment of the present invention illustrated in FIG. 1, the press apparatus 100 may comprise a control valve 22 arranged downstream the cooling unit 20 and a check valve assembly 23 arranged downstream the control valve 22. As illustrated in FIG. 1, the check valve assembly 23 takes as input the pressure medium output from the cooling unit 20 and outputs pressure medium that is fed or conveyed to the heating unit 21. As also illustrated in FIG. 1, the check valve assembly 23 is further fluidly coupled with the pump 25. The control valve 22 and the check valve assembly 23 can be used to control the flow of pressure medium output from the pressure intensifier 24. The pump 25, which may be operating at relatively low pressure, can be used to feed the pressure intensifier 24 with pressure medium, e.g., comprising oil and/or any other fluid such as water.

A pressurization phase of a treatment cycle, i.e., when the pressure in the pressure vessel 1 is increased to a certain pressure level, may involve the following operations. The pump 25 feeds the pressure intensifier 24 with pressure medium. As the pressure intensifier 24 carries out strokes, pressure is increased in the pressure medium that is input to the pressure intensifier 24 and the pressurized pressure medium is conveyed (e.g., pumped) to the check valve assembly 23. During this operation, the control valve 22 is closed (i.e., to permit no or only an insignificant amount of flow of pressure medium therethrough) and all pressure medium is conveyed (e.g., pumped) to the heating unit 21. The heat exchanger 21 may heat the pressure medium to a certain temperature or such that the temperature of the pressure medium exceeds a certain temperature before the pressure medium enters the pressure vessel 1 via the outlet 8. The pressure intensifier 24 is operated until a selected pressure level in the pressure vessel 1 has been reached. Operation of the pump 25 and the pressure intensifier 24 may then be stopped.

A pressing phase, or holding phase, of the treatment cycle, wherein any article in the pressure vessel 1 is subjected to an increased pressure (e.g., at or about a certain pressure in the pressure vessel 1 and possibly at or about at a certain temperature in the pressure vessel 1) in the pressure vessel 1 during a (e.g., selected) period of time may involve the following. During the pressing phase, the control valve 22 is open (e.g., so as to permit flow of pressure medium therethrough). Instead of pressure medium being fed to the pressure intensifier 24 by the pump 25 (as in the pressurization phase as described above), pressure medium from the cooling unit 20 is conveyed through control valve 22 and fed to the pressure intensifier 24 via the check valve assembly 23. For example by making the pressure intensifier shifting stroke direction and making pumping strokes, the pressure medium may be directed to the heating unit 21 via the check valve assembly 23. A flow rate of the pressure medium (e.g., mass flow of pressure medium) during a pressing phase may be lower that a flow rate of the pressure medium during a pressurization phase, or pumping phase. In general, the flow rate of the pressure medium may be adjusted for example by means of adjusting stroke rate and/or stroke velocity of the pressure intensifier 24.

Although the said at least one pressure medium flow generator 14 of the at least one pressure medium flow generator has been described in the foregoing as comprising a pressure intensifier 24 and a pump 25, it is to be understood that this is according to an example, and that variations are possible. For example, another or other types of pressure medium flow generator than a pressure intensifier may be employed for the said at least one pressure medium flow generator 14 of the at least one pressure medium flow generator. Thus, the said at least one pressure medium flow generator 14 of the at least one pressure medium flow generator must not necessarily comprise a pressure intensifier.

As illustrated in FIG. 1, there may be a check valve 28 or the like between the pump 25 and the pressure intensifier 24. In addition or in alternative, there could be provided one or more (additional) check valves or the like in, e.g., the said at least one pressure medium flow generator 14 of the at least one pressure medium flow generator.

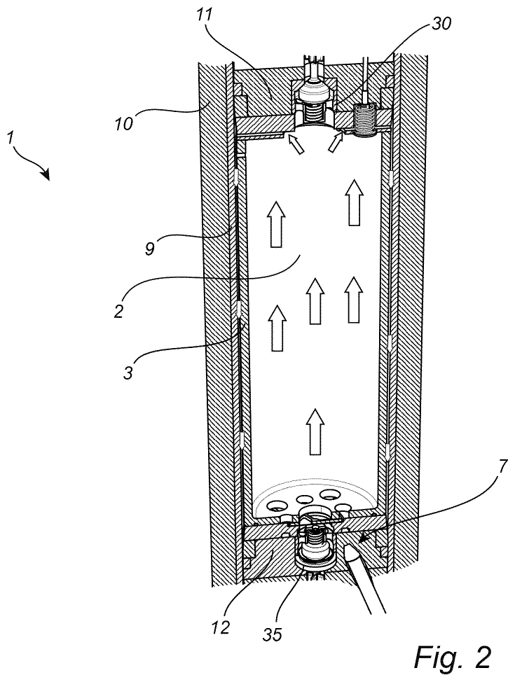

As mentioned, the pressure medium guiding path 6 might exit the pressure vessel 1 via a passage through a first end closure of the end closures of the pressure vessel 1 and enter the pressure vessel 1 via a passage through a second end closure of the end closures of the pressure vessel 1, which second end closure may be different from the first end closure. However, variations are possible. For example, the pressure medium guiding path 6 might exit the pressure vessel 1 via a passage through an end closure of the pressure vessel 1 (which for example could be the only end closure of the pressure vessel 1) and enter the pressure vessel 1 via a passage through the same end closure. An example of such a configuration is illustrated in FIGS. 2 to 5.

As has been described above, by a configuration as illustrated in FIG. 1, a circulation of pressure medium within the internal space 5 over an extended period of time may be created and/or maintained, such as during a pressing phase, or holding phase, of the treatment cycle. It is to be understood that such a circulation may be created and/or maintained also during another or other phases of a treatment cycle, such as, for example, during a pressurization phase, or pumping phase, wherein pressure medium is introduced into the pressure vessel 1 such that the pressure in the pressure vessel 1 is increased to a certain pressure level 1. For such a case, it may be beneficial to employ a configuration in which several pressure medium guiding paths are provided, each of which may be configured to guide pressure medium from an inlet to an outlet which are in fluid communication with the internal space 5. (In accordance with the embodiment of the present invention illustrated in FIG. 1, there is only one such pressure medium guiding path 6.) Each of the several pressure medium guiding paths may have its own inlet and an outlet in fluid communication with the internal space 5, or different pressure medium guiding paths may share inlet and outlet. Each or any of such several pressure medium guiding path may be outside the pressure vessel 1 and may be configured and/or arranged in accordance with (or generally in accordance with) the pressure medium guiding path 6 illustrated in FIG. 1 and as described above. For example, each or any of such several pressure medium guiding paths may be provided with the components between the inlet 7 and the outlet 8 of the pressure medium guiding path 6 illustrated in FIG. 1 and as described above. For creating and/or maintaining a circulation of pressure medium within the internal space 5 during a pressurization phase, or pumping phase, of a treatment cycle, for one or a few of the several pressure medium guiding paths the control valve 22 may be open (e.g., so as to permit flow of pressure medium therethrough), while for the other one(s) of the several pressure medium guiding paths the control valve 22 may be closed (i.e., to permit no or only an insignificant amount of flow of pressure medium therethrough). For the one or a few of the several pressure medium guiding paths for which the control valve 22 is open, the respective pressure intensifier(s) may be made to shift stroke direction and make pumping strokes, by which the pressure medium may be directed towards the pressure vessel 1 via the respective check valve assembly/assemblies.

FIG. 2 is a schematic, in part sectional view of a pressure vessel 1 of a press apparatus according to an embodiment of the present invention. The same reference numerals in FIGS. 1 and 2 denote the same or similar components, having the same or similar function.

In accordance with the embodiment of the present invention illustrated in FIG. 2, the pressure vessel 1 comprises a pressure cylinder 10 (which might be referred to only as a cylinder), a first end closure 11 and a second end closure 12. Although not explicitly illustrated in FIG. 2, one or both of the first end closure 11 and the second end closure 12 can be configured so as to be capable of being opened and closed, e.g., using opening and closing means such as known in the art. The second end closure 12 is opposite to the first end closure 11, so that the first end closure 11 and the second end closure 12 are located at opposite ends of the pressure vessel 1.

The pressure vessel 1 has an internal space 5. The pressure vessel 1 is arranged to hold pressure medium within the internal space 5 during use of the press apparatus. In accordance with the embodiment of the present invention illustrated in FIG. 2, the pressure vessel 1 comprises a load compartment 2, which is arranged within the internal space 5. The load compartment 2 is arranged so that a flow of pressure medium through the load compartment 2 is permitted. The load compartment 2 is arranged to hold at least one article therein during use of the press apparatus.

In accordance with the embodiment of the present invention illustrated in FIG. 2, the load compartment 2 is defined by the walls of a cylindrical container 3, which cylindrical container 3 may be referred to as a load basket without loss of generality, and the internal space 5 may be at least in part defined by the load compartment 2, such as for example, by an interior of a (e.g., cylindrical) container defining the load compartment 2. At least the envelope surface of the container 3 may be impervious for pressure medium. At one or more ends of the container 3 (e.g., at a bottom end and/or at a top end of the container 3) there may be provided one or more through-holes permitting passage of pressure medium therethrough, whereby a flow of pressure medium through the load compartment 2 is permitted. The container 3, or load basket, may be made of in principle any material capable of withstanding the pressures at which the at least one article is intended to be treated at. The container 3, or load basket, may for example be made of steel or another iron-based alloy. It may be preferred for the container 3, or load basket, to be made of a material having relatively low thermal conductivity, such as, for example a polymer or plastic material. Other materials having relatively low thermal conductivity are however contemplated. The load basket may have an internal structure including partitions which may have platforms or the like, which may permit placing articles on different levels in the load basket, along the length thereof.

It is to be understood that while a cylindrical geometry of the pressure vessel 1, the internal space 5 and the load compartment 2 as illustrated in FIG. 2 may be a preferable geometry—or one of the preferable geometries—such a geometry of the pressure vessel 1, the internal space 5 and the load compartment 2 is not required, and another or other types of geometries of such components are possible.

In accordance with the embodiment of the present invention illustrated in FIG. 2, the container 3 may be at least in part enclosed by an enclosure 9, e.g., a liner or jacket, which for example (and as illustrated in FIG. 2) may be cylindrical. One or both of the pressure cylinder 10 and the enclosure 9 (e.g., a liner) may be thermally insulated, e.g., by means of a relatively thin thermally insulating layer (not shown in FIG. 2) in close proximity or coupled to an inner surface of the pressure cylinder 10 and the enclosure 9, respectively.

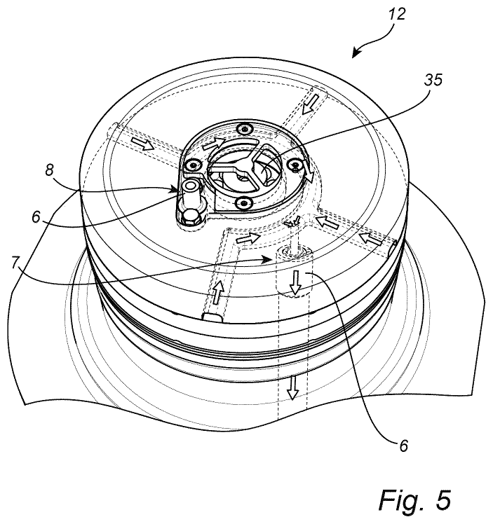

The press apparatus comprises a pressure medium guiding path 6 having and extending between an inlet 7 and an outlet (not shown in FIG. 2; cf. FIG. 5) which are in fluid communication with the internal space 5. The pressure medium guiding path 6 is configured to guide pressure medium from the inlet 7 to the outlet. As for the embodiment of the present invention illustrated in FIG. 1, the pressure medium guiding path 6 of the press apparatus illustrated in FIG. 2 is arranged at least in part outside (i.e., extending outside) the pressure vessel 1. The pressure medium flow path 6 may for example be defined by at least one of one or more tubes, one or more pipes, one or more channels, one or more conduits, etc. It is to be understood that only parts of the pressure medium guiding path 6 are depicted in FIG. 2. More specifically, only the parts of the pressure medium guiding path 6 close to the inlet 7 of the pressure medium guiding path 6 are depicted in FIG. 2, while the other parts of the pressure medium guiding path 6 are not depicted in FIG. 2. The parts of the pressure medium guiding path 6 which are outside the pressure vessel 1 may be configured and/or arranged in relation to other components of the press apparatus in accordance with an embodiment of the present invention, for example in accordance with (or generally in accordance with) the embodiment of the present invention illustrated in FIG. 1.

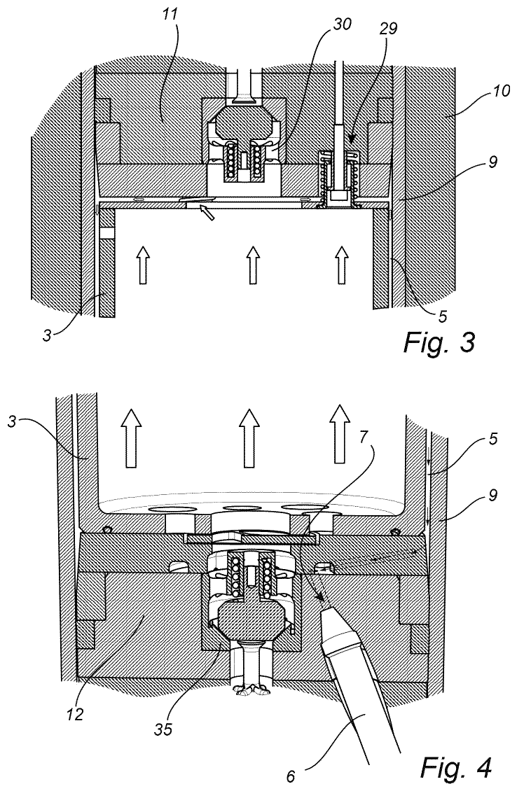

FIG. 3 is a schematic, in part sectional view of a part of the pressure vessel 1 depicted in FIG. 2 at the first end closure 11. FIG. 4 is a schematic, in part sectional view of a part of the pressure vessel 1 depicted in FIG. 2 at the second end closure 12. However, the pressure cylinder 10 is not shown in FIG. 4. FIG. 5 is a perspective view of the second end closure 12 depicted in FIG. 4.

As illustrated in FIG. 5, the pressure medium guiding path 6 has and extends between the inlet 7 and the outlet 8 which are in fluid communication with the internal space 5 (not shown in FIG. 5). Only the parts of the pressure medium guiding path 6 close to the inlet 7 and the outlet 8, respectively, of the pressure medium guiding path 6 are depicted in FIG. 5, while the other parts of the pressure medium guiding path 6 are not depicted in FIG. 5. The parts of the pressure medium guiding path 6 which are outside the pressure vessel 1 may be configured and/or arranged in relation to other components of the press apparatus in accordance with an embodiment of the present invention, for example in accordance with (or generally in accordance with) the embodiment of the present invention illustrated in FIG. 1. It is to be understood that the locations of the inlet 7 and the outlet 8 in the end closure 12 might be different from what is illustrated in FIG. 5.

As illustrated in FIGS. 2 to 5 by the arrows in the pressure vessel 1, pressure medium that is being guided in the pressure medium guiding path 6 may exit the pressure medium guiding path 6 via its outlet 8 to enter the internal space 5. Subsequently, the pressure medium is guided into the load compartment 2, which in accordance with the illustrated embodiment is realized by means of a through-hole at the bottom end of the container 3 permitting passage of pressure medium therethrough. As illustrated in FIGS. 2 to 5 by the arrows in the pressure vessel 1, a flow of pressure medium through the load compartment 2 is permitted. The pressure medium that is guided within the load compartment 2 can subsequently exit the load compartment 2 and (again) enter the internal space 5 (but at a different location in the internal space 5 than from where the pressure medium entered the load compartment 2), which in accordance with the illustrated embodiment is realized by means of a through-hole at the top end of the container 3 permitting passage of pressure medium therethrough. It is to be understood that the use of the terms “top end” and “bottom end” of the container 3 are for ease of description and in relation to how the pressure vessel 1 is depicted in FIG. 2, and does not necessarily imply a specific orientation of the pressure vessel 1 when the press apparatus is in use. It is to be understood that in any embodiment of the present invention, the pressure vessel may in use for example be arranged such that a longitudinal axis of the pressure vessel is oriented perpendicular or substantially perpendicular to a vertical line (e.g., a plumb line), or such that a longitudinal axis of the pressure vessel is oriented parallel to or substantially parallel to a vertical line (e.g., a plumb line).

As perhaps best illustrated in FIG. 2, there is a flow of pressure medium through the load compartment 2 in a direction from the bottom end of the container 3 to the top end of the container 3, or more generally from a first end of the pressure vessel 1 to a second end of the pressure vessel 1, which second end may be opposite to the first end. The flow of pressure medium passing through the through-hole at the top end of the container 3 enters a passage defined by a gap between the top end of the container 3 and a lower surface of the first end closure 11. In accordance with the illustrated embodiment and as perhaps best illustrated in FIG. 3, a spring element 29 may be provided, which may be configured to urge the container 3 towards the second end closure 12, and which thereby may facilitate or permit for forming of the passage defined by the gap between the top end of the container 3 and the lower surface of the first end closure 11. There may be provided several such spring elements for facilitating or permitting forming of the passage defined by the gap between the top end of the container 3 and the lower surface of the first end closure 11. As also illustrated in FIG. 2 as well as in FIGS. 3 and 4, the pressure medium can also flow from the gap between the top end of the container 3 and the lower surface of the first end closure 11 into a passage along the outer envelope surface of the container 3 defining the load compartment 2, in a direction from the top end of the container 3 to the bottom end of the container 3 (or in a direction towards the second end closure 12). Thus, in the illustrated embodiment of the present invention, the load compartment 2 does not take up the entirety of the internal space 5, but the internal space 5 includes a gap between the outer envelope surface of the container 3 defining the load compartment 2 and an inner surface of the pressure cylinder 10, through which gap pressure medium may flow. The pressure medium, having been guided along the outer envelope surface of the container 3 defining the load compartment 2 to the bottom end of the container 3, may then enter the inlet 7 of the pressure medium guiding passage 6. By means of at least one pressure medium flow generator, which for example may comprise one or more fans, one or more ejectors, one or more pumps and/or one or more pressure intensifiers, a flow of pressure medium within the internal space 5 between the outlet 8 of the pressure medium guiding passage 6 to the inlet 7 of the pressure medium guiding passage 6 and through the pressure medium guiding passage 6 from the inlet 7 to the outlet 8 thereof may be generated. Thereby, a circulation of pressure medium within the pressure vessel 1 may be created and/or maintained, for example over an extended period of time. In particular, a circulation of pressure medium within the internal space 5 and the load compartment 2, for example over an extended period of time, may be created and/or maintained. It is to be understood that FIGS. 2 to 5 illustrate a specific way of how a flow of pressure medium within the internal space 5 between the outlet 8 of the pressure medium guiding passage 6 to the inlet 7 of the pressure medium guiding passage 6 may be generated, and that variations are possible. For example, there may be generated a flow of pressure medium only in a portion of the internal space 5, and not necessarily in the entire internal space 5.

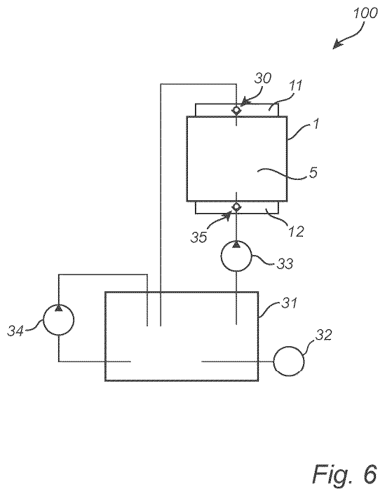

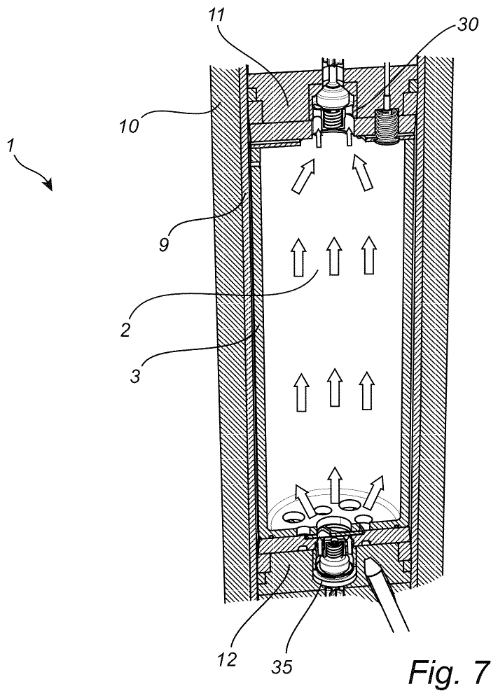

As illustrated in FIGS. 2 and 3, there may be arranged a flow restriction 30 such as, for example, a valve, in the first end closure 11. Such a flow restriction 30 may be used for fluidly coupling the pressure vessel 1 with a heating medium reservoir for holding heating medium, such as, for example, oil, for preheating any article(s) to be treated by the press apparatus 100 by means of pressure medium held within the internal space 5, prior to the treatment of the article(s) being carried out. As indicated in FIGS. 2 and 3, the flow restriction 30 may be used for fluidly coupling the pressure vessel 1 with a heating medium reservoir via the first end closure 11. Such a configuration is described further with reference to FIGS. 6 and 7 in the following. A flow restriction 35, which may be similar to or the same as the flow restriction 30, and which may be fluidly coupling the pressure vessel 1 with the heating medium reservoir via the second end closure 12 could in addition or in alternative be arranged in the second end closure 12, as illustrated in FIGS. 2, 4 and 5. For example, as described in the following with reference to FIGS. 6 and 7, a flow of heating medium from the heating medium reservoir may enter the pressure vessel 1 via the flow restriction 35 of the second end closure 12, flow through the pressure vessel 1 and leave the pressure vessel 1 via the flow restriction 30 of the first end closure 11. The flow restrictions 30, 35 may comprise or be constituted by valves, which is in accordance with the embodiment of the present invention illustrated in FIGS. 2 to 5. It is however to be understood that another or other types of flow restrictions may in alternative or in addition be used.

FIG. 6 is a schematic view of a press apparatus 100 according to an embodiment of the present invention. The same reference numerals in FIGS. 1 to 5 and in FIG. 6 denote the same or similar components, having the same or similar function. The press apparatus 100 is configured to treat at least one article (not shown in FIG. 6). At least a portion of the internal space 5 of the pressure vessel 1 is arranged to hold the at least one article.

In accordance with the embodiment of the present invention illustrated in FIG. 6, the press apparatus 100 comprises a heating medium reservoir 31, which is fluidly connected or fluidly connectable to the pressure vessel 1. The heating medium reservoir 31 is configured to hold heating medium, which for example may comprise oil. The heating medium reservoir 31 may for example comprise a tank or another appropriate type of container for holding heating medium such as oil.

As indicated in FIG. 6, the heating medium reservoir 31 may be fluidly connectable to the pressure vessel 1 by means of one or more flow restrictions 30, 35. The flow restrictions will be referred to as valves 30, 35, although it is to be understood that another or other types of flow restrictions may be used in alternative or in addition. As also indicated in FIG. 6, the press apparatus 100 comprises two valves 30, 35 arranged in respective ones of the first end closure 11 and the second end closure 12. It is however, to be understood that in principle only one valve might be needed for implementing a fluid connectability between the heating medium reservoir 31 and the pressure vessel 1. Further, each or any of the valves 30, 35 could be arranged at another location than in an end closure of the pressure vessel 1. Also, the valves 30, 35 need not necessarily to be arranged in different end closures of the pressure vessel 1, but could be arranged, e.g., in the same end closure of the pressure vessel 1.

Further in accordance with the embodiment of the present invention illustrated in FIG. 6, the press apparatus 100 comprises a heater 32, which is configured to selectively and controllably heat the heating medium in the heating medium reservoir 31. The heater 32 may for example comprise one or more electrical heaters. To facilitate for the heater 32 to (e.g., uniformly) heat the heating medium in the heating medium reservoir 31, the press apparatus 100 may comprise a pump 34 of another type of flow generator, which may be fluidly coupled with the heating medium reservoir 31 and which may be configured to circulate the heating medium in the heating medium reservoir 31. Thus, the pump 34 may be referred to as a circulation pump.

Further in accordance with the embodiment of the present invention illustrated in FIG. 6, the press apparatus 100 comprises a heating medium flow generator 33. The heating medium flow generator 33 may for example comprise a pump (e.g., a circulation pump). The heating medium flow generator 33 is configured to, prior to the pressure vessel 1 holding pressure medium within the internal space 5 for the use of the press apparatus 100, repeatedly (e.g., continuously) cause a flow of heating medium from the heating medium reservoir 31 into the pressure vessel 1 and subsequently a flow of heating medium from the pressure vessel 1 into the heating medium reservoir 31 to thereby cause a circulation of heating medium between the heating medium reservoir 31 and the pressure vessel 1 during a selected period of time.

The flow rate of the heating medium (e.g., mass flow of heating medium) in the circulation of heating medium between the heating medium reservoir 31 and the pressure vessel 1 may be significantly higher, e.g., about 10 times higher, than the flow rate of the pressure medium (e.g., mass flow of pressure medium) in the circulation of pressure medium which may be carried out during a pressing phase, or holding phase, of the treatment cycle.

The heater 32 is configured to heat the heating medium in the heating medium reservoir 31 and the heating medium flow generator 33 is configured to cause a circulation of heating medium between the heating medium reservoir 31 and the pressure vessel 1 during a selected period of time in such a way to cause any article in the internal space 5 to be heated to a selected temperature. The heating medium flow generator 33 is configured to, upon the temperature of the article(s) in the internal space 5 having reached the selected temperature, cause a flow of heating medium from the pressure vessel 1 into the heating medium reservoir 31 to withdraw the heating medium from the pressure vessel 1. The heating of any article in the internal space 5 to the selected temperature may be carried out at atmospheric pressure. The determination that the temperature of the article(s) in the internal space 5 has reached the selected temperature may for example be carried out by means of sensing temperature of the article(s), or by means of sensing one or more temperatures in the press apparatus that are indicative or representative of temperature of the article(s), using one or more temperature sensors. By temperature of the article(s), it may be meant a temperature at the surface of the article(s). The temperature of the heating medium in the internal space 5 and/or in the load compartment 2 (cf. FIGS. 2-4) may be taken as indicative or representative of the temperature of the article(s). In alternative or in addition, the temperature of the heating medium in the heating medium reservoir 31 and/or in any channel, conduit, passage, etc. fluidly coupling the heating medium reservoir 31 with the pressure vessel 1 may be taken as indicative or representative of the temperature of the article(s). The heater 32 may be controlled based on one or more values of temperature sensed in the internal space 5 and/or in the load compartment 2, and/or in the heating medium reservoir 31. To that end, there could be provided one or more temperature sensors (not shown in the figures) in the internal space 5, in the load compartment 2, in the heating medium reservoir 31 and/or in any channel, conduit, passage, etc. fluidly coupling the heating medium reservoir 31 with the pressure vessel 1.

The determination that the temperature of the article(s) in the internal space 5 has reached the selected temperature may involve determining that the temperature of the article(s) in the internal space 5 is within a certain temperature range (e.g., within a few degrees Celsius of the selected temperature), and on a condition that the temperature of the article(s) in the internal space 5 is within that temperature range, it may be deemed that the temperature of the article(s) in the internal space 5 has reached the selected temperature.

By a configuration such as illustrated in FIG. 6, the article(s) to be treated by the press apparatus 100 by means of pressure medium held within the internal space 5 may be preheated prior to the treatment of the article(s) being carried out. For example, by a configuration such as illustrated in FIG. 6, the article(s) to be treated by the press apparatus 100 by means of pressure medium held within the internal space 5 may be preheated prior to a pressurization phase of a treatment cycle being carried out.

FIG. 7 is a schematic, in part sectional view of a pressure vessel 1 of a press apparatus according to an embodiment of the present invention. The pressure vessel 1 illustrated in FIG. 7 has the same construction as the pressure vessel 1 illustrated in FIG. 2. The same reference numerals in FIGS. 7 and 2 denote the same or similar components, having the same or similar function. With reference to the embodiment of the present invention illustrated in FIG. 6, the arrows in the pressure vessel 1 illustrated in FIG. 7 indicate how heating medium from the heating medium reservoir 31 may flow through the pressure vessel 1, and in particular through the internal space 5 and the load compartment 2, during a circulation of heating medium between the heating medium reservoir 31 and the pressure vessel 1, e.g., during a selected period of time, such as described in the foregoing with reference to FIG. 6. As illustrated in FIG. 7 by the arrows in the pressure vessel 1, the flow of heating medium from the heating medium reservoir 31 may enter the pressure vessel 1 via the flow restriction 35, flow through the pressure vessel 1 and leave the pressure vessel 1 via the flow restriction 30.

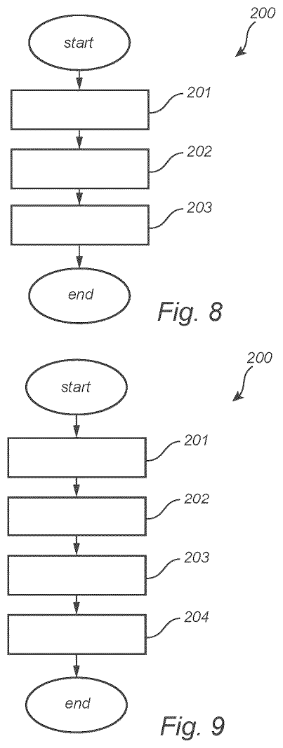

FIG. 8 is a schematic flowchart of a method 200 according to an embodiment of the present invention. The method 200 is carried out in a press apparatus. The press apparatus comprises a pressure vessel having an internal space. The pressure vessel is arranged to hold pressure medium within the internal space during use of the press apparatus. The press apparatus comprises at least one pressure medium guiding path. The at least one pressure medium guiding path has and extends between an inlet and an outlet, which are in fluid communication with the internal space. The at least one pressure medium guiding path is configured to guide pressure medium from the inlet to the outlet. The press apparatus comprises at least one pressure medium flow generator, which is configured to controllably generate a flow of pressure medium into the inlet, through the at least one pressure medium guiding path, and out of the outlet. The press apparatus comprises a cooling unit, which is arranged downstream the inlet, and which is configured to controllably cool the pressure medium being guided in the at least one pressure medium guiding path.

The method 200 comprises, at 201, controlling the at least one pressure medium flow generator to generate a flow of pressure medium into the inlet and towards the cooling unit. At least one of the at least one pressure medium flow generator is arranged downstream the cooling unit and is configured to receive the flow of the pressure medium having been cooled by the cooling unit.

The method 200 comprises, at 202, controlling the at least one of the at least one pressure medium flow generator to generate a flow of the pressure medium in the at least one pressure medium guiding path towards the outlet.

The method 200 comprises, at 203, controlling the cooling unit to cool the pressure medium being guided in the at least one pressure medium guiding path such that the temperature of the pressure medium received by said at least one of the at least one pressure medium flow generator does not exceed a first selected temperature.

After 203, the method 200 may end. However, the method 200 may be carried out repeatedly during an extended period of time, during which extended period of time a circulation of pressure medium within the pressure vessel is created and/or maintained.

FIG. 9 is a schematic flowchart of a method 200 according to an embodiment of the present invention. The method 200 illustrated in FIG. 9 is similar to the method 200 illustrated in FIG. 8, and includes the actions or steps 201, 202 and 203 as described in the foregoing with reference to the method 200 illustrated in FIG. 8. The method 200 illustrated in FIG. 9 includes an additional step or action 204. According to the embodiment of the present invention illustrated in FIG. 9, the press apparatus may comprise a heating unit. The heating unit may be arranged downstream said at least one of the at least one pressure medium flow generator and upstream the outlet. The heating unit may be configured to controllably heat the pressure medium being guided in the at least one pressure medium guiding path such that the temperature of the pressure medium in the pressure medium flow out of the outlet is equal to or exceeds a second selected temperature. The method 200 illustrated in FIG. 9 comprises, at 204, controlling the heating unit to heat the pressure medium being guided in the at least one pressure medium guiding path such that the temperature of the pressure medium in the pressure medium flow out of the outlet is equal to or exceeds a second selected temperature.

After 204, the method 200 illustrated in FIG. 9 may end. However, the method 200 illustrated in FIG. 9 may be carried out repeatedly during an extended period of time, during which extended period of time a circulation of pressure medium within the pressure vessel is created and/or maintained.

In conclusion, a press apparatus is disclosed, comprising a pressure vessel having an internal space and at least one pressure medium guiding path having and extending between an inlet and an outlet in fluid communication with the internal space. The press apparatus comprises a cooling unit arranged downstream the inlet and configured to cool pressure medium being guided in the at least one pressure medium guiding path. At least one pressure medium flow generator is arranged downstream the cooling unit and configured to receive the flow of the pressure medium having been cooled by the cooling unit such that the temperature of the pressure medium does not exceed a first selected temperature and generate a flow of the pressure medium in the at least one pressure medium guiding path towards the outlet. A related method is also disclosed.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A press apparatus comprising:
a pressure vessel having an internal space, the pressure vessel being arranged to hold pressure medium within the internal space during use of the press apparatus;
at least one pressure medium guiding path having and extending between an inlet and an outlet in fluid communication with the internal space, the at least one pressure medium guiding path being configured to guide pressure medium from the inlet to the outlet;
at least one pressure medium flow generator configured to generate a flow of pressure medium into the inlet, through the at least one pressure medium guiding path, and out of the outlet; and
a cooling unit arranged downstream the inlet and configured to cool the pressure medium being guided in the at least one pressure medium guiding path;
wherein at least one of the at least one pressure medium flow generator is arranged downstream the cooling unit and configured to receive the flow of the pressure medium having been cooled by the cooling unit and generate a flow of the pressure medium in the at least one pressure medium guiding path towards the outlet;
wherein the cooling unit is configured to cool the pressure medium being guided in the at least one pressure medium guiding path such that the temperature of the pressure medium received by said at least one of the at least one pressure medium flow generator does not exceed a first selected temperature.

2. A press apparatus according to claim 1, wherein said at least one of the at least one pressure medium flow generator is associated with a nominal maximum pressure medium temperature being a temperature which the pressure medium received by said at least one of the at least one pressure medium flow generator is not permitted to exceed, wherein the first selected temperature is equal to the nominal maximum pressure medium temperature.

3. A press apparatus according to claim 1, further comprising:
a heating unit arranged downstream said at least one of the at least one pressure medium flow generator and upstream the outlet and configured to heat the pressure medium being guided in the at least one pressure medium guiding path such that the temperature of the pressure medium in the pressure medium flow out of the outlet is equal to or exceeds a second selected temperature.

4. (canceled)

5. A press apparatus according to claim 1, wherein the at least one pressure medium guiding path is arranged at least in part outside the pressure vessel.

6. A press apparatus according to claim 1, wherein said at least one of the at least one pressure medium flow generator comprises at least one pressure intensifier.

7. A press apparatus according to claim 1, wherein the heating unit and/or the cooling unit comprises at least one heat exchanger unit.

8. A press apparatus according to claim 1, wherein the at least one pressure medium guiding path is configured to guide pressure medium out of the internal space and into the inlet, guide the pressure medium introduced into the inlet from the inlet to the outlet, and guide the pressure medium out of the outlet and back into the internal space.

9. A press apparatus according to claim 1, wherein the press apparatus is configured to treat at least one article, and wherein the press apparatus further comprises a load compartment arranged within the internal space and arranged so that a flow of pressure medium through the load compartment is permitted, the load compartment being arranged to hold at least one article therein during use of the press apparatus.

10. A press apparatus according to claim 1, wherein the at least one pressure medium flow generator is further configured to generate a flow of pressure medium within the internal space in a direction from the outlet to the inlet.

11. A press apparatus according to claim 1, wherein the pressure vessel comprises at least one end closure, wherein the at least one pressure medium guiding path exits the pressure vessel via a passage through an end closure of the pressure vessel and enters the pressure vessel via a passage through the same end closure.

12. A press apparatus according to claim 1, wherein the pressure vessel comprises at least two end closures, wherein the at least one pressure medium guiding path exits the pressure vessel via a passage through a first end closure of the end closures of the pressure vessel and enters the pressure vessel via a passage through a second end closure of the end closures of the pressure vessel, wherein the second end closure is different from the first end closure.

13. A press apparatus according to claim 1, wherein the press apparatus is configured to treat at least one article, and wherein at least a portion of the internal space is arranged to hold the at least one article, the press apparatus further comprising:
a heating medium reservoir fluidly connected or fluidly connectable to the pressure vessel;
at least one heater configured to selectively and controllably heat the heating medium in the heating medium reservoir;
at least one heating medium flow generator configured to, prior to the pressure vessel holding pressure medium within the internal space for the use of the press apparatus, repeatedly cause a flow of heating medium from the heating medium reservoir into the pressure vessel and subsequently a flow of heating medium from the pressure vessel into the heating medium reservoir to thereby cause a circulation of heating medium between the heating medium reservoir and the pressure vessel during a selected period of time;
wherein the at least one heater is configured to heat the heating medium in the heating medium reservoir and the at least one heating medium flow generator is configured to cause a circulation of heating medium between the heating medium reservoir and the pressure vessel during a selected period of time in such a way to cause any article in the internal space to be heated to a selected temperature, wherein the at least one heating medium flow generator is configured to, upon the temperature of the article(s) in the internal space having reached the selected temperature, cause a flow of heating medium from the pressure vessel into the heating medium reservoir to withdraw the heating medium from the pressure vessel.

14. A method in a press apparatus, the press apparatus comprising a pressure vessel having an internal space, the pressure vessel being arranged to hold pressure medium within the internal space during use of the press apparatus, at least one pressure medium guiding path having and extending between an inlet and an outlet in fluid communication with the internal space, the at least one pressure medium guiding path being configured to guide pressure medium from the inlet to the outlet, at least one pressure medium flow generator configured to controllably generate a flow of pressure medium into the inlet, through the at least one pressure medium guiding path, and out of the outlet, and a cooling unit arranged downstream the inlet and configured to controllably cool the pressure medium being guided in the at least one pressure medium guiding path, the method comprising:
controlling the at least one pressure medium flow generator to generate a flow of pressure medium into the inlet and towards the cooling unit;
wherein at least one of the at least one pressure medium flow generator is arranged downstream the cooling unit and configured to receive the flow of the pressure medium having been cooled by the cooling unit, the method further comprising:
controlling the at least one of the at least one pressure medium flow generator to generate a flow of the pressure medium in the at least one pressure medium guiding path towards the outlet; and
controlling the cooling unit to cool the pressure medium being guided in the at least one pressure medium guiding path such that the temperature of the pressure medium received by said at least one of the at least one pressure medium flow generator does not exceed a first selected temperature.

15. A method according to claim 14, wherein the press apparatus further comprises a heating unit arranged downstream said at least one of the at least one pressure medium flow generator and upstream the outlet and configured to controllably heat the pressure medium being guided in the at least one pressure medium guiding path, wherein the method further comprises:
controlling the heating unit to heat the pressure medium being guided in the at least one pressure medium guiding path such that the temperature of the pressure medium in the pressure medium flow out of the outlet is equal to or exceeds a second selected temperature.

16. A computer program product configured to, when executed in a control unit configured to control operation of a press apparatus according to the method according to claim 13.

17. A computer-readable storage medium on which there is stored a computer program product configured to, when executed in a control unit configured to control operation of a press apparatus according to method according to claim 13.

18. A method according to claim 14, wherein during use of the press apparatus, the pressure medium upon flowing into the inlet has a temperature equal to a certain temperature or within a certain temperature range, wherein the certain temperature exceeds the first selected temperature, or the certain temperature range includes temperatures exceeding the first selected temperature, wherein the second selected temperature is equal to the certain temperature or is within the certain temperature range.
